(19) United States
(12) Patent Application Publication
(10) Pub. No.: US 2022/0067716 A1
(43) Pub. Date: Mar. 3, 2022

(54) SYSTEM AND METHOD FOR UTILIZING MULTI-PEGGED DIGITAL CONTRACTS AS PART OF PAYMENT PROCESSING

(71) Applicant: FinAgility Inc., Savannah, GA (US)

(72) Inventor: Dragos Stanescu, Bucharest (RO)

(21) Appl. No.: 17/445,289

(22) Filed: Aug. 17, 2021

Related U.S. Application Data
(60) Provisional application No. 63/073,331, filed on Sep. 1, 2020.

(51) Int. Cl. G06Q 20/38

(52) U.S. Cl. CPC G06Q 20/389

(57) ABSTRACT

A system and method for utilizing multi-pegged digital contracts as part of a payment processing system.

### PRIORITY CLAIM

This application claims the benefit of and priority to U.S. Provisional Patent Application No. 63/073,331, filed on Sep. 1, 2020, the entire contents of which is incorporated herein by reference.

### TECHNICAL FIELD

The present disclosure relates to a system and method for utilizing multi-pegged digital contracts as part of a payment processing system. More particularly, various embodiments of the present disclosure provide a system and method for employing multi-pegged digital contracts which the system dynamically maintains in a one-to-one correspondence to the dynamic balance of FIAT currency in the aggregated client accounts associated with the system to accomplish a 100% proof of claim system.

### BACKGROUND

The transfer of funds using certain banking systems are relatively slow and often take multiple days to complete. For example, an interbank transfer of funds from one banking account of one bank to another banking account of another bank typically takes one to two days for the funds to clear and settle utilizing the automated clearing house (“ACH”) electronic network for financial transactions. In another example, a transfer of funds from one banking account of one bank to another banking account of another bank utilizing a correspondent account system typically takes three to five days for the funds to clear and settle. Additionally, while the access to funds from a credit card account (such as via a cash advance from the credit card account or otherwise transferring funds from the credit card account) are typically quicker, such transactions are associated with relatively large fees (e.g., 2% to 8%) of the funds being accessed. Accordingly, there is a need for a fund transfer/payment processing system that settles and clears the transferred funds relatively quickly (compared to existing banking systems) and relatively inexpensively (compared to existing credit card systems).

Additionally, while certain cryptocurrency systems purport to employ a digital payment network for financial transactions that is both relatively quick (compared to existing banking systems), relatively inexpensive (compared to existing credit card systems) and stable (i.e., backed by a reserve asset), these cryptocurrency systems are disfavored by both banking institutions and central banks, such as the U.S. Federal Reserve Banks, the European Central Bank, and the Bank of England. For example, while the Ripple network uses a distributed consensus ledger of a network of validating servers and the cryptocurrency of XRP tokens (which are backed by FIAT currency reserves), since the XRP tokens are actively traded on a cryptocurrency exchange (and thus the price of XRP tokens fluctuates over time, even if in a narrow margin), the volatility of XRP tokens (as well as Libra and certain other stable cryptocurrencies) as payment carriers is generally unacceptable to banking institutions seeking to avoid any associated Forex risk. In another example, since XRP tokens (as well as Libra and certain other stable cryptocurrencies) utilize a decentralized blockchain to track transactions, when accounting for the number of participating financial institutions and the relatively easy determination of patterns (even of coded digital currency wallets), the transparency of such transactions (and specifically the visibility of such transactions by unauthorized third parties) is generally unacceptable to banking institutions. In yet another example, while cryptocurrencies classified as stable coins introduce a new currency within the money supply, such currency is not subject to the monetary policy of central banks and is thus generally regarded by central banks as an unregulated currency that threatens national sovereignty. Accordingly, there is a need for a fund transfer/payment processing system that is accepted by both banking institutions and central banks.

### SUMMARY

The present disclosure generally relates to a payment system and method that employs pegged digital contracts associated with different FIAT currencies to ensure a relatively quick (compared to existing banking systems), relatively inexpensive (compared to existing credit card systems and interbank clearing and settlement systems) and stable fund transfer/payment processing system acceptable to both banking institutions and central banks. In addition to general acceptance by both banking institutions and central banks, the system and method of the present disclosure benefits both participating retailers and individuals via at least the reduced transaction costs and quicker settlement time compared to existing payment processing systems.

In various embodiments, the system utilizes a pegged digital contract (“PDC”) which comprises a digital contract dynamically issued for each and every currency in the aggregated client accounts associated with the system. Specifically, in certain embodiments, the system maintains that, at all times, the total aggregate amount of PDCs in existence associated with each FIAT currency is pegged at a static ratio, such as 1:1, to the total aggregate balance of each FIAT currency held in the aggregated client accounts. In these embodiments, the system maintains this static ratio via a permanent issue and burn mechanism in a blockchain backbone that is linked to incoming FIAT currency in the aggregate client accounts, outgoing FIAT currency in the aggregate client accounts and FIAT currency conversions within the system. For example, for a transaction including converting ten euros (“EUR”) from a first account associated with euros to an amount of U.S. dollars (“USD”) associated with a second account, when accounting for an employed 1 EUR to 1.1 USD currency exchange rate, the system not only completes the transaction in a manner of seconds by decreasing the first account associated with euros by ten EURs and increasing the second account associated with USD by eleven USDs, but the system additionally makes blockchain PDC adjustments of burning ten EUR PDCs in the blockchain backbone and issuing eleven USD PDCs in the blockchain backbone. In this example, because eleven USDs entered the aggregate client accounts via the transaction, the system created eleven USD PDCs in the blockchain backbone to maintain the static 1:1 USD to USD PDC ratio. Similarly, because ten EURs left the aggregate client accounts via the transaction, the system eliminated or burned ten EUR PDCs in the blockchain backbone to maintain the static 1:1 EUR to EUR PDC ratio. As illustrated by this example, by maintaining a static 1:1 PDC to FIAT currency ratio at all times (i.e., 1 EUR PDC is always equal to 1 EUR of currency), banking institutions run no exchange rate fluctuation risk associated to the PDC as a payment carrier in facilitating such a transfer. Additionally, by completing each transaction in a manner of seconds (i.e., the system can settle up to 14,000 transactions per second), banking institutions reduce the amount of float within the banking system. Moreover, since all the client electronic wallets are kept in custody in a centralized wallet belonging to the system, the transfer of funds from one banking client to another banking client will be operated in PDCs in those bank's respective electronic wallets, such that any unauthorized third party is only able to track blockchain moves in the centralized wallet, thereby rending all transactions invisible to such unauthorized third parties. Furthermore, because each PDC is not a digital currency, but rather a digitalized transfer tool of national/regional currencies issued by the central banks in the countries/regions of operations, the employment of such PDCs poses no risk of any new currency being issued in a monetary territory (as preferred by central banks). Accordingly, by permanently supplying and burning pegged digital contracts in a blockchain backbone based on the movement of FIAT currency into and out from the aggregated client accounts of the system (to maintain a constant static ratio of PDCs in the system to FIAT currencies in the system) the system of the present disclosure is operable to provide a relatively highly stable and secure transfer/payment carrier system.

These and other embodiments, and various permutations and aspects, will become apparent and be more fully understood from the following detailed description and drawings, which set forth illustrative embodiments that are indicative of the various ways in which the principles of the invention may be employed.

### BRIEF DESCRIPTION OF THE DRAWINGS

FIG. 1 is a flow chart of an example process of creating a user account in association with a sign up process of the system of various embodiments of the present disclosure.

FIG. 2 is a flow chart of an example process of creating a client account in association with a sign in process of the system of various embodiments of the present disclosure.

FIG. 3 is a flow chart of an example process of transferring funds in the same currency in association with the system of various embodiments of the present disclosure.

FIG. 4 is a flow chart of an example process of transferring funds in different currencies in association with the system of various embodiments of the present disclosure.

FIG. 5 is a schematic diagram of an example process of burning and issuing PDCs in association with a currency conversion of the system of various embodiments of the present disclosure.

FIG. 6 is a schematic diagram of an example process of burning and issuing PDCs in association with the entrance and exit of currency of the system of various embodiments of the present disclosure.

FIG. 7 is a schematic diagram illustrating different computing components utilized to operate the system of various embodiments of the present disclosure.

### DETAILED DESCRIPTION

The description that follows describes and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the disclosure explains exemplary systems including components for one or more of the embodiments contemplated herein, it should be understood that with respect to each embodiment, one or more components may not be present or necessary in the system.

It should also be noted that the disclosures made in this specification are in accordance with the principles of the embodiments(s), which are intended to be disclosed or interpreted to their broadest extent under the patent laws of the United States and other countries, and while such disclosure may describe or otherwise cover subject matter that may be regulated by other existing laws or regulations in the United States and other countries, including, without limitation, the U.S. Treasury Department Financial Crimes Enforcement Network (“FinCEN”), nothing in this disclosure is intended to suggest or imply noncompliance with any such law or regulation by the assignee.

In various embodiments, the payment system of the present disclosure utilizes one or more PDCs as a transfer/payment carrier to facilitate the digital transfer of FIAT currencies using blockchain technology. In such embodiments, the system maintains a constant ratio of each PDC to its respective associated FIAT currency (e.g., each USD PDC is equal to one USD) and additionally maintains that the total aggregate amount of PDCs in existence associated with each FIAT currency remains linked to the amount of such FIAT currency held or otherwise associated with the client accounts. For example, if the system includes $10,000 USD held in one or more client accounts and the system employs a constant 1 USD PDC to 1 USD ratio, the system employs blockchain technology to ensure that 10,000 USD PDCs are currently in existence in association with a blockchain.

Specifically, the system maintains that, at all times, the total aggregate amount of PDCs associated with each currency in existence in the blockchain is pegged at a static ratio, such as 1:1, to the total aggregate balance of that currency held in the aggregated client accounts. To maintain this static ratio, the system employs a permanent issue and burn mechanism in a blockchain backbone that is linked to both incoming currency and outgoing currency in the aggregate client accounts. For example, if $10 USD are transferred from a client account associated with the system to an account not associated with the system, since $10 USD has left the aggregate client accounts of USDs, the system burns or otherwise removes 10 USD PDCs from the blockchain such that 10 less USD PDCs are part of the ecosystem of the present disclosure. In another example, if $10 USD is introduced into a client's account, such as by a verified individual whom has opened a new client account with $10 USD, since $10 USD has been added to the aggregate client accounts of USDs, the system issues or otherwise creates 10 USD PDCs in the blockchain such that 10 more USD PDCs are part of the ecosystem of the present disclosure. It should thus be appreciated that maintaining a static 1:1 PDC to FIAT currency ratio at all times through the permanent supplying and burning of digital contracts in the blockchain enables the fund transfer/payment processing system to settle and clear transferred funds relatively quickly (compared to existing banking systems), relatively inexpensively (compared to existing credit card systems and interbank clearing and settlement systems) and in a way that is acceptable by both banking institutions and central banks.

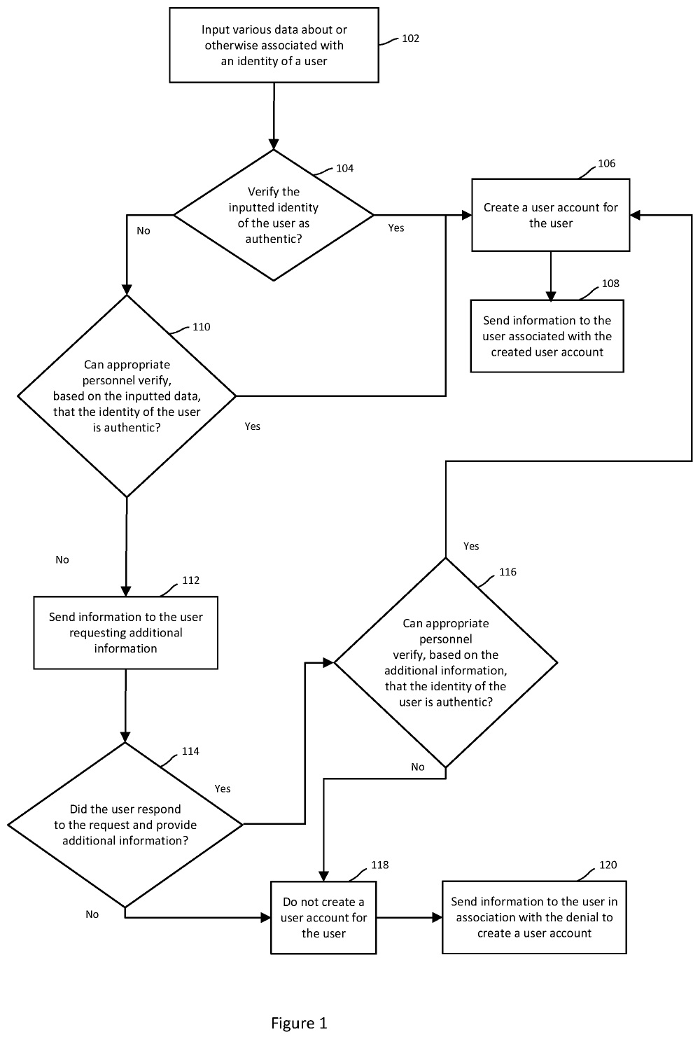

More specifically, in certain embodiments, to create a user account to utilize the system of the present disclosure, a user accesses the system (such as by launching a mobile device application or visiting a designated website with a website browser) and, as seen in block 102 of FIG. 1, inputs various data about or otherwise associated with an identity of the user, such as, but not limited to, surname, first name, current address, previous address, citizenship, email, date of birth, personal/social security number, sex, place of birth, information associated with a government issued identification (i.e., issuing authority, date of issue, expiration date), a picture of a personal document and/or a picture of the user's face. As indicated in diamond 104, the system then attempts to verify, based on the obtained personal identifying data and with the user's consent, that the inputted identity of the user is authentic. In certain embodiments, this verification includes the system operating with one or more identify verification systems to run one or more criminal background checks on the user, such as determining if the user is on any list of known criminals maintained by any law enforcement agency, such as the FBI or Interpol. In certain embodiments, this verification additionally or alternatively includes a thorough know your customer (“KYC”) verification process including face recognition, comparison of ID documents, biometric data, ultimate beneficial owner checks, and/or third party recommendations/checks. In one such embodiment, the system employs artificial intelligence to verify a user's identification card using a high-speed multi-layer image scan wherein the system redraws the identification card and a picture of the user's face to a three-dimensional model (as well as reads the data of the user's presented identification cared) in an attempt to verify the identity of the user.

If the system verifies that the user's identification is authentic, as indicated in blocks 106 and 108, the system creates a user account for the user (or places the user information into a queue for user account creation) and sends information to the user associated with the created user account, such as an email to the user including a username and expiring PIN that needs to be used within 24 hours to activate the account.

On the other hand, if the system is unable to verify that the user's identification is authentic, as indicated in diamond 110, the system tasks appropriate personnel to attempt to determine, based on the obtained personal identifying data, if the identity of the user is authentic. That is, the system utilizes human oversight with checking the personal identifying data provided by the user to potentially override the system's determination that the identity of the user is not authentic (or the system's inability to determine that the identification of a user is authentic). For example, if the system is unable to verify an identification of the user via a visual verification of the user's identification card compared to a picture of the user taken with the mobile device application, the system triggers a human operator assisted compliant KYC procedure as a second layer of verification.

If the human intervention is able to verify the user's identification, the system returns to blocks 106 and 108 to create a user account for the user and send information to the user associated with the created user account. On the other hand, if the human intervention is unable to verify the user's identification as authentic, as indicated in block 112, the system sends information to the user requesting additional information, such as the system sending an email to the user requesting a copy of/explanation to the user's criminal record and/or one or more fiscal records associated with the user.

As seen in diamonds 114 and 116, if the user responds to the request and provides additional information, the system tasks appropriate personnel to attempt to determine, based on the additional information provided by the user, if the identity of the user is authentic. If the human intervention verifies, based on the additional information, that the user's identification is authentic, the system returns to blocks 106 and 108 to create a user account for the user and send information associated with the created user account to the user. On the other hand, if the human intervention does not verify the user's identification based on the additional information (e.g., the appropriate personnel determines that something on the user's criminal record prohibits the system from creating an account for the user) or if the user does not respond to the request for additional information, as indicated in blocks 118 and 120, the system does not create a user account for the user and sends information to the user in association with the denial to create a user account, such as an email explaining that the system is unable to open a user account for the user at the current time or that the user is barred from the system.

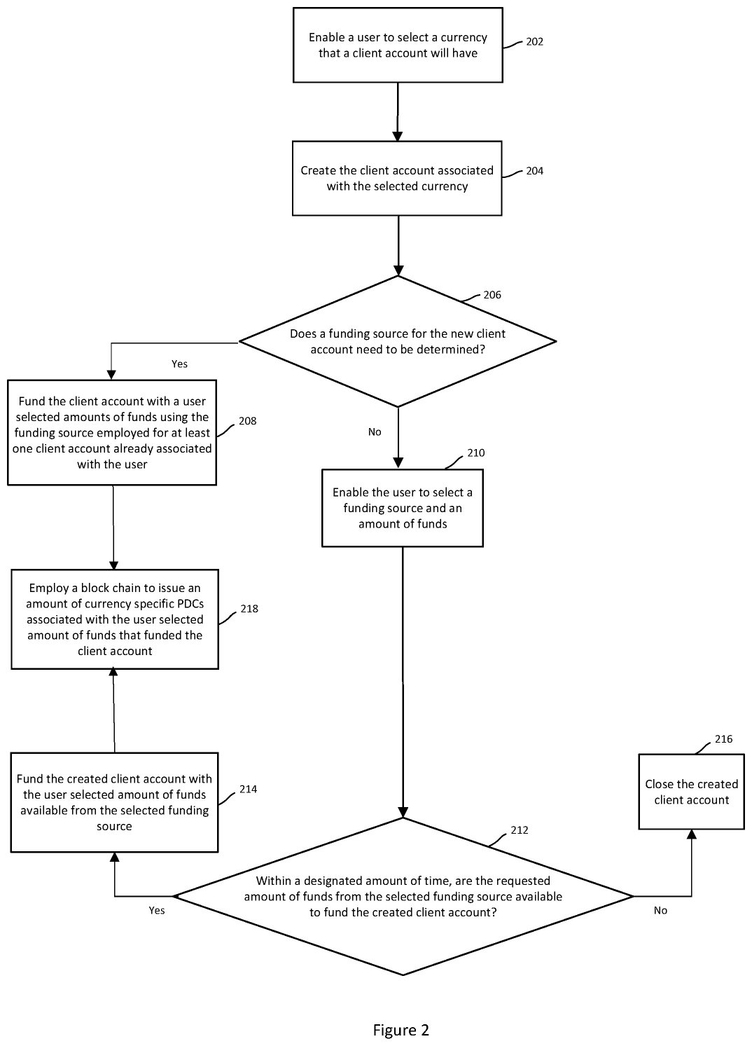

In various embodiments, following the creation of a user account, the system operates to create and/or fund one or more client accounts associated with the created user account. Specifically, as seen in block 202 of FIG. 2, following the user opening a mobile application associated with the system on a mobile device, the system enables the user to select a currency that a client account will have. It should be appreciated that each different currency is associated with an individual client account such that if the user wants to utilize different currencies, the system will maintain different client accounts (associated with such different currencies) for that user.

Following the selection of a currency that the client account will have, the system creates the client account associated with the selected currency as indicated in block 204. Since each currency is associated with a different client account (and a different electronic wallet associated with a corresponding amount of PDCs), upon the selection of a new currency by the user, the system (and more specifically, in certain embodiments, a core banking application) creates a new client account for that new currency.

It should be appreciated that the aggregated client account (with separate partitions for each client) is opened with a financial institution, such as a bank, wherein the system of the present disclosure (and/or an authorized agent of the system) operates as a payment processor, based on user instructions, with the financial institution acting as a custodian of the aggregated clients account. That is, no operations on any client account occurs without the verification by a custodian bank of client instructions wherein such verification is accomplished via direct access of the custodian bank to the payment processing system of the present disclosure. It should be further appreciated that the opening of each client account and any transaction associated with such client accounts (e.g., a transfer of funds to or from the client account) is, at all time, transparent to any regulatory authority overseeing such client accounts and/or such transactions to ensure compliance with banking, securities, and anti-money laundering regulations. Moreover, since the system of the present disclosure is conFIG.d to interconnect with public treasurers at central and local government levels, the transparency of the system provides that, when implemented, the system of the present disclosure facilitates enhanced monitoring of tax liabilities (resulting in high collection rates) as well as the instant and reduced cost collection of taxes (and issuing of tax refunds).

After the creation of a new client account associated with a newly selected currency, the system determines if a funding source for the new client account needs to be determined as indicated in diamond 206. In this example, since the system is operable to utilize the same funding source across different client accounts associated with different currencies, the system determines whether any other client accounts associated with any other currencies are associated with the user. Put differently, the system determines if the created client account associated with the selected currency is the first client account for the user.

If the system determines that at least one funding source associated with at least one other client account associated with at least one other currency is associated with the user, as indicated in block 208, the system funds the client account with the user selected amount of funds using the funding source employed for the at least one client account already associated with the user.

On the other hand, if the system determines that no funding source is associated with any client account associated with any currency associated with the user, as indicated in block 210, the system enables the user to select a funding source (e.g., a bank or a credit card) and an amount of funds. In one example, if the user selects to fund the created client account with funds being maintained in a bank account, the system enables the user to select (and/or manually input) information about a partner bank (e.g., the name of the bank, a bank routing number, a bank account number) where the requested amount of funds will be drawn from. In another example, if the user selects to fund the created client account with funds from a credit card, the system enables the user to select (and/or manually input) information about the credit card (e.g., the name on the credit card, the credit card number, the credit card expiration date, the card verification value) where the requested amount of funds will be drawn from.

Following the selection of a funding source, for a designated amount of time, such as 48 hours after the selection of a funding source, the system periodically determines whether the requested amount of funds from the selected funding source are available to fund the created client account as indicated in diamond 212 of FIG. 2. If the system determines that the requested amount of funds from the selected funding source are available, as indicated in block 214, the system funds the created client account with the user selected amount of funds with the funds available from the selected funding source. On the other hand, if the system determines that after the designated amount of time that the requested amount of funds are not available from the selected funding source, as indicated in block 216, the system closes the created client account.

Following the funding of a requested amount of funds in a selected currency to a client account associated with a user (either from a new or existing funding source), as indicated in block 218 and described in more detail below, the system employs the blockchain (and specifically a private blockchain with three validators wherein all validators are controlled by the same platform to result in a centralized blockchain rather than a decentralized blockchain) to issue a corresponding amount of currency specific PDCs in the client wallet associated with the user selected amount funds that funded the client FIAT currency account. Specifically, since the system maintains that the total aggregate amount of PDCs in existence associated with each currency remains linked to the amount of such currency held or otherwise associated with the client accounts, if the system funds a client account with an amount of currency from a source of funds external to the system, the system employs a blockchain transaction to issue or otherwise create a corresponding amount of PDCs to maintain the static ratio. For example, if the system creates a client account for a user and funds the client account with $100 USD from a credit card (i.e., an occurrence of a currency entrance event), to maintain that, at all times, the total aggregate amount of PDCs in existence associated with each currency is pegged at a static 1:1 ratio to the total aggregate balance of that currency held in the aggregated client accounts, the system utilizes a blockchain component of the application or platform to issue or write 100 USD PDCs in association with the user, such as in a PDC digital wallet associated with the user, to account for the $100 USD being transferred into a client account of the system. Accordingly, when new funds in any applicable currency enter any client account of the system, the system accounts for such funds entering the system by creating, in the blockchain, a corresponding amount of PDCs in association with the currency to maintain that the total aggregate amount of PDCs in existence associated with each currency remains pegged at a static ratio to the total aggregate balance of that currency held in the aggregated client accounts.

Conversely, following the transferring of a requested amount of funds in a selected currency from a client account associated with a user to a destination outside of the system, the system employs suitable blockchain technology to remove or otherwise burn a corresponding amount of currency specific PDCs from the system. For example, if the system transfers $50 EUR from a client account to a bank account not associated with the system (i.e. an occurrence of a currency exit event), to maintain that, at all times, the total aggregate amount of PDCs in existence associated with each currency is pegged at a static 1:1 ratio to the total aggregate balance of that currency held in the aggregated client accounts, the system utilizes the blockchain component of the application or platform to burn 50 EUR PDCs to account for the $50 EUR being transferred away from a client account of the system. Accordingly, when funds in any applicable currency are removed from any client account of the system (and not simply transferred to another client account of the system), the system accounts for such funds leaving the system by burning, in the blockchain, a corresponding amount of PDCs in association with the currency to maintain that the total aggregate amount of PDCs in existence associated with each currency remains pegged at a static ratio to the total aggregate balance of that currency held in the aggregated client accounts.

In certain embodiments, the blockchain technology employed by the system includes a private blockchain component or layer of the application or platform that is based on Cosmos technology and the Tendermint consensus and distribution engine and the Cosmos SDK. In these embodiments, the Tendermint consensus and distribution engine enables approximately 14,000 settled transactions per second utilizing at least three validators distributed in different data centers (to ensure system redundancy and integrity) and further enables financial institutions, such as banks, with the ability to run their own validators to further enhance security. Such a private blockchain backbone acts as a safety mechanism wherein transactions cannot be reverted (to prevent double spend) and each transaction only happens on the private blockchain after the transaction has been successfully completed and validated in the banking core (to provide that economic attacks are relatively easily determined by the system). Such a private blockchain backbone is further operational to employ persistent cross-checking wherein in the event of a bypassing attempt of the centralized layer (by an attempted interaction with the blockchain directly), the banking core component of the application and the blockchain component of the application will cross reference the transaction values of the attempted transaction and in case of a discrepancies between the transaction values, an error condition will occur and the system will be halted.

In various embodiments, following the funding of a client account with an amount of funds in a specific currency and following the issuance of a corresponding amount of PDCs associated with that specific currency, the system enables the user to utilize such PDCs as a digital transfer tool of the specific currency.

In certain embodiments, the system enables the user to utilize one or more PDCs as a digital transfer tool of a specific FIAT currency in association with a transfer of funds from one registered user to another registered user. In these embodiments, following a first user utilizing the mobile device application to request a transfer of funds of a FIAT currency to a second user and following the system employing a private blockchain to transfer PDCs associated with the FIAT currency from the first user to the second user, the system transfers the FIAT currency from an account of the first user to an account of a second user.

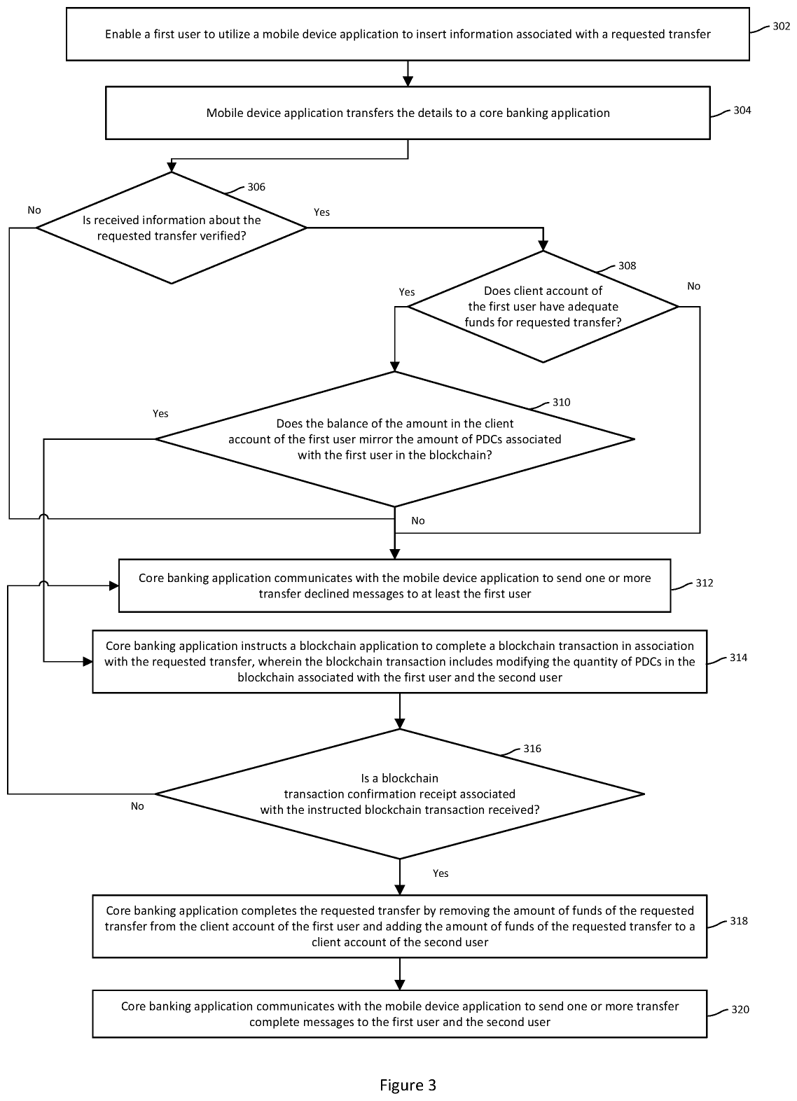

Specifically, as seen in block 302 of FIG. 3, the system enables a first user to utilize a mobile device application to insert information associated with a requested transfer. In certain embodiments, this information includes information about the first user, information about from which client account associated with the first user to transfer funds from, information about the amount of the transfer, and/or information about a second user whom is to receive the transfer (e.g., the beneficiary's name, the beneficiary's bank information and the beneficiary's account number).

After the first user utilizes the mobile device application to specify the details of the requested transfer, the mobile device application transfers the details to a core banking application as seen in block 304. That is, since the verifications associated with the transfer are performed at the core banking level (and not the mobile device application level), the system transfers the relevant details to an application being run at the core banking level. It should be appreciated that if the core banking application determines, as described below, that the first user's account lacks adequate funds to complete the transfer or the requested transfer is otherwise problematic (e.g., the information entered for the transfer is incomplete or incorrect), the core banking application communicates one or more messages to the mobile device application which then notifies the first user of the issue and prompts the first user to again utilize the mobile device application to insert information associated with the requested transfer.

As seen in diamonds 306 and 308, upon receiving the information from the mobile device application regarding the requested transfer, the core banking application verifies the received information about the requested transfer, and verifies that the client account of the first user has the funds to complete the requested transfer. As seen in block 310, the core banking application also verifies that the balance of the amount in the client account of the first user mirrors the amount of PDCs associated with the first user in the blockchain. Put differently, since the system maintains a static 1:1 ratio of funds in a client account associated with a user to PDCs in a blockchain associated with that user, the system utilizes this statically maintained ratio to verify that the amount of FIAT currency in the client account is the same as the amount of PDCs associated with that FIAT currency indicated in the blockchain.

In this illustrated example, if the core banking application is unable to verify any of the received information about the requested transfer, that the client account of the first user has the funds to complete the requested transfer or that the balance of the amount in the client account of the first user mirrors the amount of PDCs in the blockchain associated with the first user, as indicated in block 312, the core banking application communicates with the mobile device application to send one or more transfer declined messages to at least the first user. In certain embodiments, the transfer declined messages inform the first user (and in certain embodiments, the second user too) of the issue and prompt the first user to again utilize the mobile device application to insert information associated with a requested transfer.

On the other hand, if the core banking application verifies each of the received information about the requested transfer, that the client account of the first user has the funds to complete the requested transfer and that the balance of the amount in the client account of the first user mirrors the amount of PDCs in the blockchain associated with the first user, as indicated in block 314, the core banking application instructs the blockchain component of the application or platform to complete a blockchain transaction in association with the requested transfer, wherein the blockchain transaction includes modifying the quantity of PDCs in the blockchain associated with the first user and the second user. Specifically, to complete the blockchain transaction, the blockchain component of the application modifies the blockchain to remove or otherwise disassociate an amount of PDCs associated with the amount of the requested transfer from being associated with the first user, and modifies the blockchain to add or otherwise associate the amount of PDCs associated with the amount of the requested transfer to be associated the second user. Following such modifications, the blockchain component of the application emits a blockchain transaction confirmation receipt.

Following the core banking application instructing the blockchain component of the application to execute the blockchain transaction, as indicated in block 316, the core banking application awaits for an indication of the blockchain transaction confirmation receipt associated with the instructed blockchain transaction. If the blockchain transaction confirmation receipt is not received, then as indicated in block 312 and described above, the core banking application communicates with the mobile device application to send one or more transfer declined messages to at least the first user.

On the other hand, if the blockchain transaction confirmation receipt is received, then as indicated in block 318, the core banking application completes the requested transaction by removing the amount of funds of the requested transfer from the client account of the first user, and adding the amount of funds of the requested transfer to a client account of the second user. It should be appreciated that since the system maintains a static 1:1 ratio of funds in a client account associated with a user to PDCs in a blockchain associated with that user, if the system modifies the amount of PDCs in the blockchain that are associated with a user, the system will then modify the amount of funds in the client account associated with that user. In other words, the system utilizes this statically maintained ratio of funds in a client account to PDCs in the blockchain to instantly transfer funds between different accounts without requiring periodic settlements throughout the day and thus operate in a significantly quicker manner than existing fund transfer mechanisms.

Following the core banking application modification of the amount of funds in different accounts maintained for different users based on the modification of PDCs in the blockchain, as seen in block 320, the core banking application communicates with the mobile device application to send one or more transfer complete messages to the first user and the second user. In different embodiments, such transfer complete messages include, but are not limited to, the time of the transfer, the amount transferred, the current fund balance in the client account associated with that user and/or the current amount of PDCs in the blockchain associated with that user.

In certain embodiments, the system enables the user to utilize one or more PDCs as a digital transfer tool in association with a transfer of funds including the conversion of one form of currency to another form of currency. In these embodiments, following a first user utilizing the mobile device application to request a transfer of funds in the form of a first currency to a second user in the form of a second currency and following the system employing a private blockchain to burn PDCs associated with the first currency from the blockchain associated with the first user and issue PDCs associated with the second currency in the blockchain associated with the second user, the system completes the fund transfer including funding the second account of the second user with the second currency.

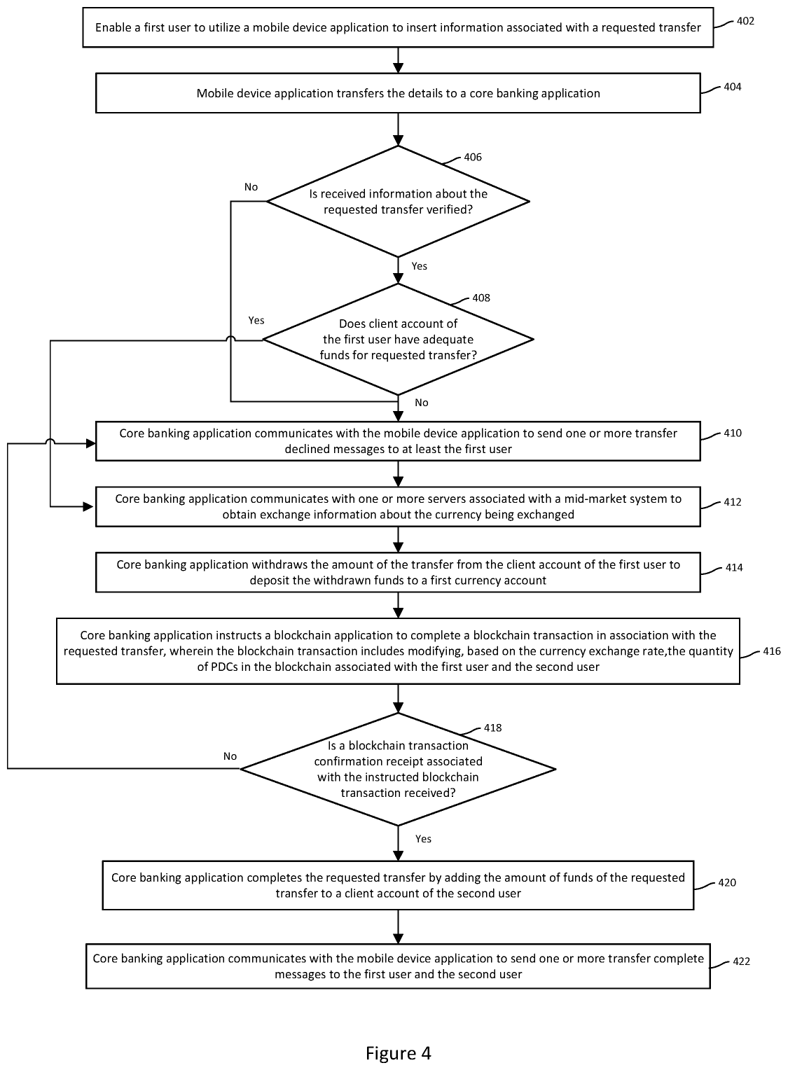

Specifically, as seen in block 402 of FIG. 4, the system enables a first user to utilize a mobile device application to insert information associated with the requested transfer. In certain embodiments, this information includes information about the first user, information about from which client account associated with the first user to transfer funds from, information about the amount of the transfer, information about the form of the transfer (e.g., the transfer will include one account sending funds in the form of a first FIAT currency to another account holding funds in the form of a second, different FIAT currency), information about the currency exchange rate to employ, and/or information about a second user whom is to receive the transfer (e.g., the beneficiary's name, the beneficiary's bank information and the beneficiary's account number).

After the first user utilizes a mobile device application to specify the details of the requested transfer, as described above with respect to FIG. 3, the mobile device application transfers the details to a core banking application as seen in block 404. Upon receiving the information from the mobile device application regarding the requested transfer, as seen in blocks 406 and 408, the core banking application attempts to verify the received information about the requested transfer, and that the client account of the first user has the funds to complete the requested transfer. It should be appreciated that in certain embodiments, the system verifies that the balance of the amount in the client account of the first user mirrors the amount of PDCs in the blockchain associated with the first user as explained above.

In this illustrated example, if the core banking application is unable to verify any of the received information about the requested transfer or that the client account of the first user has the funds to complete the requested transfer, as indicated in block 410, the core banking application communicates with the mobile device application to send one or more transfer declined messages to at least the first user. In certain embodiments, the transfer declined messages inform the first user (and in certain embodiments, the second user too) of the issue and prompt the first user to again utilize the mobile device application to insert information associated with the requested transfer.

On the other hand, if the core banking application verifies that the received information about the requested transfer and that the client account of the first user has the funds to complete the requested transfer, as seen in blocks 412 and 414, the core banking application communicates with one or more servers associated with a mid-market system to obtain exchange information about the currency being exchanged and withdraws the amount of the transfer from the client account of the first user to deposit the withdrawn funds to a first currency account. That is, in certain embodiments, to convert funds from one type of FIAT currency to another type of FIAT currency, the system employs an applicable FIAT currency exchange rate and one or more designated currency accounts to facilitate the transaction.

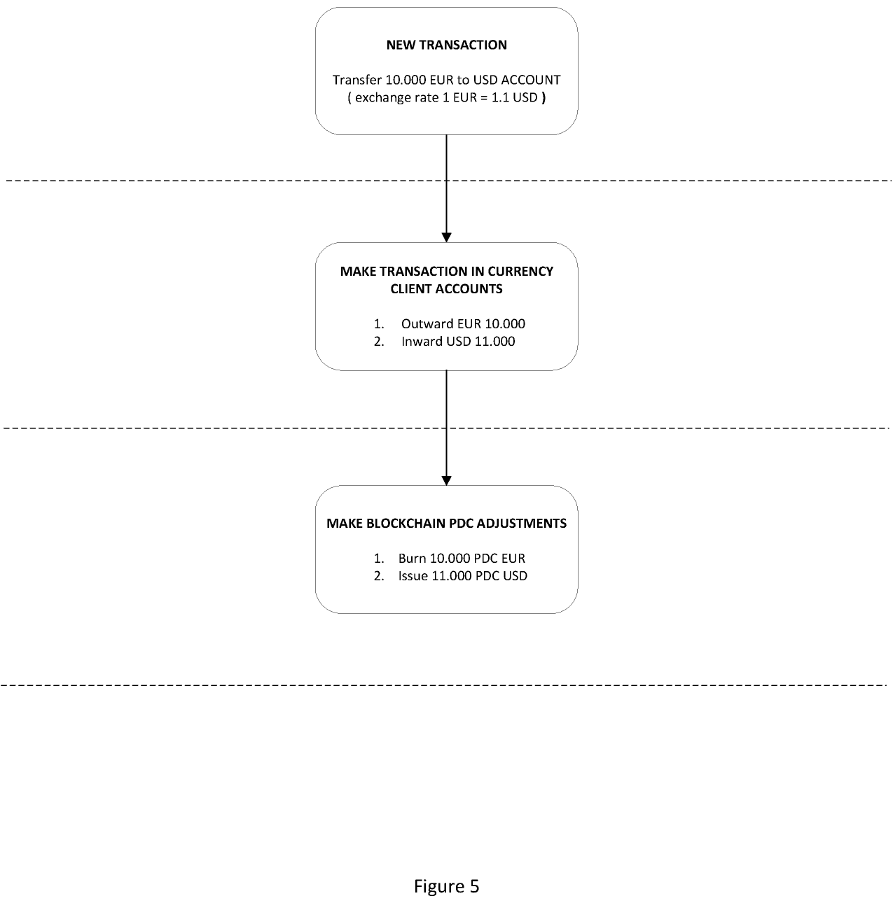

As indicated in block 416, the core banking application then instructs the blockchain component of the application or platform to complete a blockchain transaction in association with the requested transfer, wherein the blockchain transaction includes modifying, based on the currency exchange rate, the quantity of PDCs in the blockchain associated with the first user and the second user. Specifically, to complete the blockchain transaction, the blockchain component of the application modifies the blockchain to burn an amount of PDCs of the first currency associated with the amount of the requested transfer from the blockchain, and issue the amount of PDCs of the second currency associated with the amount of the requested transfer in the blockchain. It should be appreciated that since the transfer of this embodiment includes the system converting, based on an applicable exchange rate, a first amount of a first type of currency to a second amount of a second type of currency, the first amount of the first type of currency is exiting the system and the second amount of the second type of currency is entering the system. As such, since the system maintains that, at all times, the total aggregate amount of PDCs in existence associated with each currency is pegged at a static ratio, such as 1:1, to the total aggregate balance of each currency held in the aggregated client accounts, the system burns, in the blockchain, PDCs corresponding to the first amount of the first type of currency removed from first client account and further issues, in the blockchain, PDCs corresponding to the second amount of the second type of currency added to the second client account. For example, as seen in FIG. 5, for a transfer of ten-thousand euros from a first account associated with euros to a second account associated with U.S. dollars, when accounting for a 1 EUR to 1.1 USD currency conversion, the system makes blockchain PDC adjustments of burning ten-thousand EUR PDCs and issuing eleven-thousand USD PDCs.

Following the core banking application instructing the blockchain component of the application to execute the blockchain transaction, as indicated in block 418, the core banking application awaits for an indication of a blockchain transaction confirmation receipt associated with the instructed blockchain transaction. If the blockchain transaction confirmation receipt is not received, then as indicated in block 410 and described above, the core banking application communicates with the mobile device application to send one or more transfer declined messages to at least the first user.

On the other hand, since the system maintains a static 1:1 ratio of funds in a client account associated with a user to PDCs in a blockchain associated with that user, if the system modifies the amount of PDCs associated with a user in the blockchain (as evidenced by the receipt of a confirmation of a blockchain transaction), the system will modify the amount of funds in the client account associated with that user. Specifically, if the blockchain transaction confirmation receipt is received, then as indicated in block 420, the core banking application adds the amount of the requested transfer to a client account of the second user.

Following the core banking application modification of currency in different accounts maintained for different users based on the modification of PDCs in the blockchain, as seen in block 422, the core banking application communicates with the mobile device application to send one or more transfer complete messages to the first user and the second user. In different embodiments, such transfer complete messages include, but are not limited to, the time of the transfer, the amount transferred, the current fund balance in the client account associated with that user and/or the current amount of PDCs in the blockchain associated with that user.

In certain embodiments (not shown), the system enables a user to invest in various private banking activities wherein the system employs the core banking application to facilitate such features. In these embodiments, upon a user utilizing a mobile application of a mobile device to select an amount the user wants to invest and from which client account to withdraw the funds from, the mobile device application notifies the core banking application to initiate the private banking activities with the funds selected by the user. In these embodiments, upon the completion of the private banking activities, the core banking application proceeds to transfer the funds back to the client account selected by the user and notifies the user of the availability of such funds. In such embodiments, as described above, the system employs PDCs to facilitate the transfer of funds between accounts in a manner that is relatively quicker and more secure than existing fund transfer mechanisms available.

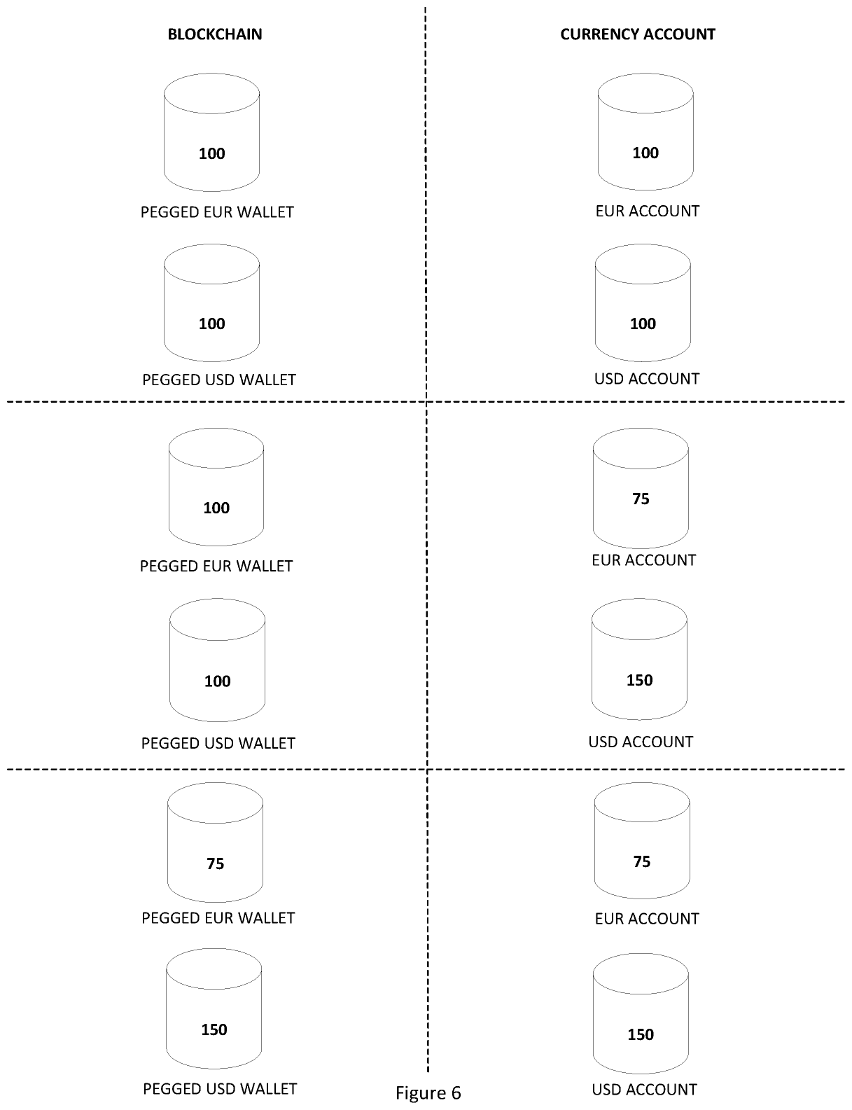

As described above, the system of the present disclosure operates as a secure payment processing system via the utilization of PDCs and the maintained relationship between such PDCs and the amount of FIAT currency held in the aggregated client accounts associated with the system. That is, the system employs a suitable issue and burn mechanism in the blockchain backbone to ensure that, at all times, the total aggregate amount of PDCs in existence associated with each currency is pegged at a static ratio, such as 1:1, to the total aggregate balance of each currency held in the aggregated client accounts. For example, as seen in FIG. 6, prior to one or more transactions, the system maintains that, for each FIAT currency, a quantity of that currency held in the aggregate client accounts (e.g., 100 EUR held in a EUR currency account and 100 USD held in a USD currency account) corresponds to a quantity of PDCs maintained by the system (e.g., 100 PDC EUR and 100 PDC USD accounted for in the blockchain). In this example, following one or more transactions which result in the removal of FIAT currency from the aggregate client accounts and/or the addition of FIAT currency into the aggregate client accounts (e.g., the reduction of the amount of EUR held in the EUR currency account to 75 EUR and the increase of the amount of USD held in the USD currency account to 150 USD), the system burns and/or issues a corresponding quantity of PDCs to mirror such currency transaction (e.g., the burning of 25 PDC EURs from the blockchain such that 75 PDC EUR remain in existence and the issuing of 50 PDC USD in the blockchain such that 150 PDC USD are now in existence). As illustrated by this example, by permanently supplying and burning pegged digital contracts in a blockchain backbone based on the movement of FIAT currency into and out from the aggregated client accounts of the system (to maintain a constant static ratio of PDCs in the system to FIAT currencies in the system), the system of the present disclosure provides 100% proof of claim for the PDCs thereby increasing the integrity of the transfer/payment carrier system disclosed herein.

In certain embodiments, to enhance security of the digital transfer tool of the present disclosure, the system utilizes multiple security layers including: (i) a virtual card, (ii) a virtual point-of-sale (“POS”) terminal, (iii) a unique QR code for each transaction (which is valid for both the virtual card and the virtual POS terminal, and (iv) a matching of data between different application layers of the system. In these embodiments, the virtual card is created for and embedded in or otherwise attached to a user's account, wherein unlike a physical card, the virtual card is accessible from a mobile device application being executed on a mobile device to enable higher security with respect to information theft. In these embodiments, the unique QR code for each transaction provides that any transaction which involves the movement of PDCs (and thus the movement of FIAT currency) generates a unique QR code for the virtual card (and, in certain instances, for a virtual POS terminal, wherein to initiate a transaction (to cause the generation of a unique QR code), the user needs to verify their identity, such as via entering their unique username and password and/or via employing one or more biometric authentication technologies (e.g., fingerprint recognition technology, facial recognition technology).

In certain embodiments, as indicated above, the system of the present disclosure enables the transfer of funds (facilitated by PDCs as a digitalized fund transfer tool) from a customer to a retailer utilizing a virtual card and a virtual POS terminal associated with the retailer. In these embodiments, since the PDCs are used as the fund transfer tool (and not traditional credit card networks and their associated fee structure), multiple parties each realize one or more benefits.

Specifically, retailers realize a benefit in lower POS transaction costs (compared to traditional credit card payment processors), and instant settlement of transactions. Moreover, since each user of the system provides various information to the system to verify their identity, without identifying any individual customers, the system offers retailers the ability to access, daily if requested, dedicated/aggregated data analytics of their customers including, but not limited to, the types of goods and/or services purchased, the customer's age, the customer's gender, the customer's income and/or the customer's education level, wherein the data may be broken down by POS terminal, by location, and/or by demographic group.

Individuals and companies associated with the system also realize a benefit via instant and reduced cost transfers and payments as well as preferred rates (from the employment of mid-market rates). Additionally, since the system enables users to participate in private banking activities without imposing an income threshold and further with utilizing high limits (or even no limits) on the amount of funds that can be transacted at one time, individuals and companies benefit by increased financial freedom and alternative investment opportunities.

Moreover, financial institutions associated with the system realize a benefit via the elimination of acquisition/depreciation costs for the virtual POS terminal, the elimination of maintenance costs for any physical POS terminal, the elimination of a need to dedicate a secure line to facilitate any credit card transactions. Additionally, financial institutions associated with the system realize a benefit via quicker transaction completion times (which reduces float). Furthermore, based on the system verifying each user's identity prior to enabling the user to create any account and conduct any transactions as well as based on the multi-layered security described herein, all parties realize a reduction in costs related to fraud and/or insurance policies.

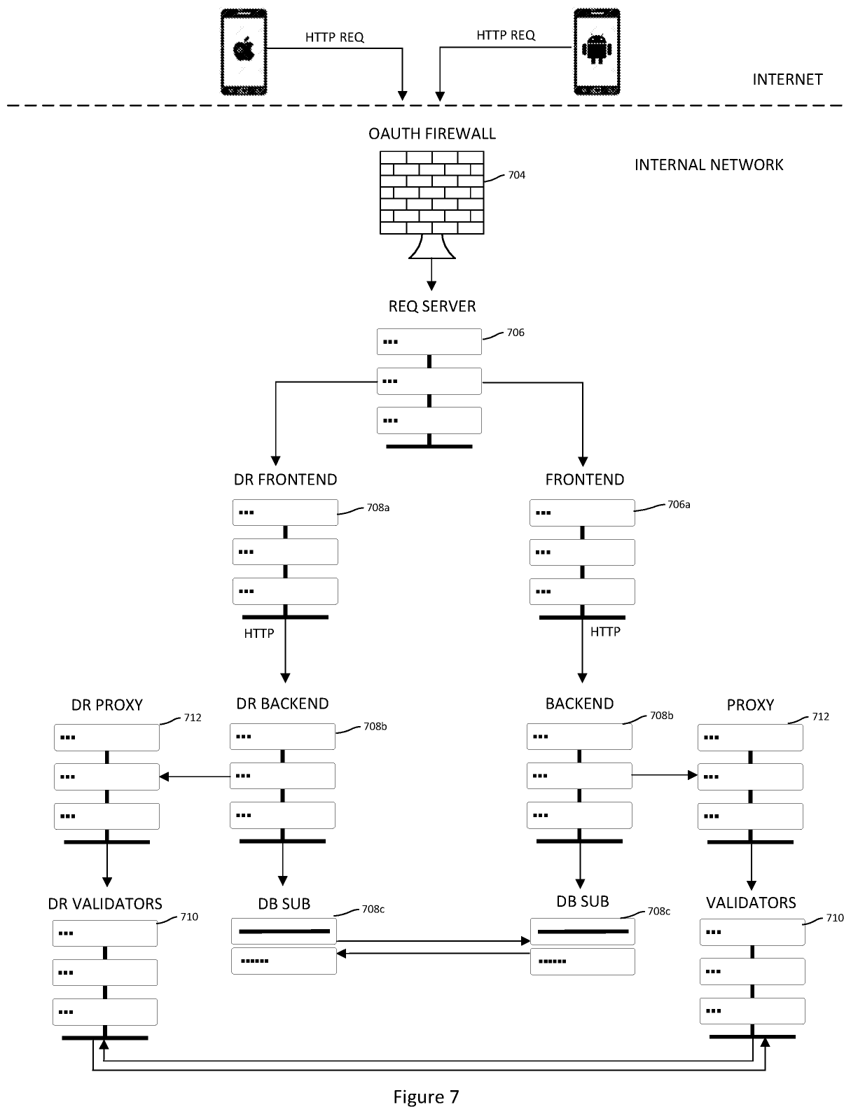

In certain embodiments, the system of the present disclosure includes one or more computing devices housing executable software used to facilitate one or more components of the system and/or one or more components of other systems which interface with one or more components of the system. In these embodiments, one or more instances of the computing device may be utilized to implement any, some, or all of the components of any system disclosed herein. For example, as seen in FIG. 7, following enabling a user to access a mobile device application with their mobile device 702, the system employs one or more authentication servers 704 (which determine if the user has privileges to connect to and interface with the system), one or more request servers 706 (which function as a load balancer and disaster recovery system that switches requests between operational servers and disaster recover servers), one or more operational servers 708 (including frontend servers 708a, backend servers 708b and database servers 708c) and components of a blockchain ecosystem (including validators 710 and for one or more validators, a proxy 712 in front of them).

In various embodiments, a computing device includes a memory element. Memory element may include a computer readable medium for implementing any component of any system disclosed herein, and for implementing particular system transactions. Computing device also contains executable software, some of which may or may not be unique to the system.

In some embodiments, the system is implemented in software, as an executable program, and is executed by one or more special or general purpose digital computer(s), such as a mainframe computer, a commodity server, a personal computer (desktop, laptop or otherwise), a personal digital assistant, or other handheld or mobile computing device, such as a mobile phone. Therefore, computing device may be representative of any computer in which the system resides or partially resides.

Generally, in terms of hardware architecture, computing device includes a processor, a memory, and one or more input and/or output (I/O) devices (or peripherals) that are communicatively coupled via an interface. Interface may be one or more buses or other wired or wireless connections. Interface may have additional elements, which are omitted for simplicity, such as controllers, buffers (caches), drivers, transmitters, and receivers to facilitate external communications with other like or dissimilar computing devices. Further, interface may include address, control, and/or data connections to enable internal communications among the other computer components.

Processor is a hardware device for executing software, particularly software stored in memory. Processor can be any custom made or commercially available processor. Processor may also represent multiple parallel or distributed processors working in unison.

Memory can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory can have a distributed architecture where various components are situated remote from one another, but are still accessed by processor. These other components may reside on devices located elsewhere on a network or in a cloud arrangement.

The software in memory may include one or more separate programs. The separate programs comprise ordered listings of executable instructions for implementing logical functions. The software in memory may include the system in accordance with the present disclosure, and a suitable operating system (O/S). The operating system O/S will depend on the type of computing device. Operating system essentially controls the execution of other computer programs, such as the system, and provides scheduling, input-output control, file and data management, memory management, and communication control and related services.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions. That is, computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a local computer, partly on the local computer, as a stand-alone software package, partly on the local computer and partly on a remote computer or entirely on the remote computer or server. In the latter scenario, the remote computer may be connected to the local computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS). Components of the system may also be written in a proprietary language developed to interact with these known languages.

I/O device may include input devices such as a keyboard, a mouse, a scanner, a microphone, a touch screen, a bar code reader, or an infra-red reader. It may also include output devices such as a printer, a video display, an audio speaker or headphone port or a projector. I/O device may also comprise devices that communicate with inputs or outputs, such as a short-range transceiver (RFID, Bluetooth, etc.), a telephonic interface, a cellular communication port, a router, or other types of network communication equipment. I/O device may be internal to computing device, or may be external and connected wirelessly or via connection cable, such as through a universal serial bus port.

When computing device is in operation, processor is conFIG.d to execute software stored within memory, to communicate data to and from memory, and to generally control operations of computing device pursuant to the software. The system and operating system, in whole or in part, may be read by processor, buffered within processor, and then executed.

In the context of this document, a “computer-readable medium” may be any means that can store, communicate, propagate, or transport data objects for use by or in connection with the system. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system can be embodied in any type of computer-readable medium for use by or in connection with an instruction execution system or apparatus, such as a computer.

For purposes of connecting to other computing devices, computing device is equipped with network communication equipment and circuitry. In certain embodiments, the network communication equipment includes a network card such as an Ethernet card, or a wireless connection card. In a preferred network environment, each of the plurality of computing devices on the network is conFIG.d to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while one embodiment of the invention is for each computing device to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

Any process descriptions or blocks in FIG.s should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A system comprising:
a processor; and
a memory device that stores a plurality of instructions that, when executed by the processor, cause the processor to:
responsive to a currency entrance event associated with a first amount of currency, cause a corresponding first quantity of pegged digital contracts to be issued in a blockchain; and
responsive to a currency exit event associated with a second amount of currency, cause a corresponding second quantity of pegged digital contracts to be burned from the blockchain.

2. The system of claim 1, wherein at least one of the currency entrance event and the currency exit event occurs in association with a modification of an amount of funds associated with a client account maintained in association with a financial institution.

3. The system of claim 2, wherein an authenticated user is associated with a plurality of different client accounts maintained in association with the financial institution.

4. The system of claim 3, wherein each of the plurality of different client accounts is associated with a different currency of a plurality of different currencies.

5. The system of claim 1, wherein the first amount of currency and the corresponding first quantity of pegged digital contracts are based on a first static ratio of a total aggregate amount of pegged digital contracts associated with a first currency to a total aggregate balance of the first currency held in each client account associated with the first currency.

6. The system of claim 5, wherein the second amount of currency and the corresponding second quantity of pegged digital contracts are based on a second static ratio of a total aggregate amount of pegged digital contracts associated with a second currency to a total aggregate balance of the second currency held in each client account associated with the second currency.

7. The system of claim 6, wherein the first currency is different from the second currency and the first static ratio equals the second static ratio.

8. The system of claim 1, wherein the memory device stores a plurality of further instructions that, when executed by the processor following the first quantity of pegged digital contracts issued in the blockchain, cause the processor to enable at least one pegged digital contract of the first quantity of pegged digital contracts to be transferred from a first user to a second user.

9. The system of claim 8, wherein the memory device stores another plurality of further instructions that, when executed by the processor following the transfer of the at least one pegged digital contract of the first quantity of pegged digital contracts from the first user to the second user, cause the processor to cause a transmission of data associated with a transfer of a third amount of currency corresponding to the at least one pegged digital contract from a first client account associated with the first user to a second client account associated with the second user.

10. A system comprising:
a processor; and
a memory device that stores a plurality of instructions that, when executed by the processor responsive to a currency conversion event associated with a first amount of a first currency to a second amount of a second, different currency, cause the processor to:
cause a first quantity of pegged digital contracts corresponding to the first amount of the first currency to be burned from a blockchain; and
cause a second quantity of pegged digital contracts corresponding to the second amount of the second, different currency to be issued in the blockchain.

11. The system of claim 10, wherein following the first quantity of pegged digital contracts corresponding to the first amount of the first currency burned from the blockchain and the second quantity of pegged digital contracts corresponding to the second amount of the second, different currency issued in the blockchain, a total aggregate amount of pegged digital contracts associated with the first currency corresponds to a total aggregate balance of the first currency held in each client account associated with the first currency and a total aggregate amount of pegged digital contracts associated with the second, different currency corresponds to a total aggregate balance of the second, different currency held in each client account associated with the second, different currency.

12. A method of operating a system, the method comprising:
responsive to a currency entrance event associated with a first amount of currency, causing, by a processor, a corresponding first quantity of pegged digital contracts to be issued in a blockchain; and
responsive to a currency exit event associated with a second amount of currency, causing, by the processor, a corresponding second quantity of pegged digital contracts to be burned from the blockchain.

13. The method of claim 12, wherein at least one of the currency entrance event and the currency exit event occurs in association with a modification of an amount of funds associated with a client account maintained in association with a financial institution.

14. The method of claim 13, wherein an authenticated user is associated with a plurality of different client accounts maintained in association with the financial institution.

15. The method of claim 14, wherein each of the plurality of different client accounts is associated with a different currency of a plurality of different currencies.

16. The method of claim 12, wherein the first amount of currency and the corresponding first quantity of pegged digital contracts are based on a first static ratio of a total aggregate amount of pegged digital contracts associated with a first currency to a total aggregate balance of the first currency held in each client account associated with the first currency.

17. The method of claim 16, wherein the second amount of currency and the corresponding second quantity of pegged digital contracts are based on a second static ratio of a total aggregate amount of pegged digital contracts associated with a second currency to a total aggregate balance of the second currency held in each client account associated with the second currency.

18. The method of claim 17, wherein the first currency is different from the second currency and the first static ratio equals the second static ratio.

19. The method of claim 12, further comprising, following the first quantity of pegged digital contracts issued in the blockchain, enabling, by the processor, at least one pegged digital contract of the first quantity of pegged digital contracts to be transferred from a first user to a second user.

20. The method of claim 19, further comprising, following the transfer of the at least one pegged digital contract of the first quantity of pegged digital contracts from the first user to the second user, causing, by the processor, a transmission of data associated with a transfer of a third amount of currency corresponding to the at least one pegged digital contract from a first client account associated with the first user to a second client account associated with the second user.
